(19) United States
(12) Patent Application Publication
(10) Pub. No.: US 2007/0120035 A1
(43) Pub. Date: May 31, 2007

(54) In-ground anchor structure for interchangeable posts and signs

(76) Inventors: George Albanese, Longview, TX (US); Curtis Cooper, Tyler, TX (US)

Correspondence Address: RONALD B. SEFRNA, P.O. BOX 567, TYLER, TX, 75710, US

(21) Appl. No.: 11/595,785

(22) Filed: Nov. 9, 2006

Related U.S. Application Data
(60) Provisional application No. 60/736,080, filed on Nov. 10, 2005.

(51) Int. Cl. F16M 13/00

(52) U.S. Cl. 248/530

(57) ABSTRACT

An in-ground anchor structure for supporting posts for signs and the like includes a ground anchor assembly with an elongate ground penetrating spike and a mounting plate connected to the upper end of the spike in perpendicular relation thereto, and a post mounting assembly with a base plate to be received on and removably connected to the mounting plate of the ground anchor assembly and a post receiver formed as a hollow sleeve with an open upper end connected to the base plate and extending upwardly therefrom. The ground anchor assembly is driven into the ground until the mounting plate is flush with or slightly below the surface, the post mounting assembly is connected to the ground anchor assembly, and a post is secured to the sleeve. In an alternative embodiment the ground anchor assembly includes a screw shaft and screw plate in place of the spike.

### RELATED APPLICATION DATA

This application claims the benefit of U.S. Provisional Patent Application Ser. No. 60/736,080, filed Nov. 10, 2005.

### FIELD OF THE INVENTION

The present invention generally relates to embedded ground anchors, and in its preferred embodiments more specifically relates to an anchor to be embedded in the ground for supporting posts of various configurations and sizes for any purpose, either permanently or temporarily.

### BACKGROUND OF THE INVENTION

The placement of both temporary and permanent signs for a variety of purposes is commonplace. It is common for temporary signs to be erected for a period of time, removed, and either the same sign or another sign to be erected in the same location at another time. Permanent signs may be renewed or replaced from time to time with another sign structure. The conventional method of placing a sign involves excavating a hole for each sign post, placing the sign post(s) in the holes, and filling around the post with the excavated soil or with concrete. This approach is not only labor intensive and time consuming, but also damaging to lawns and the like where the signs are placed. Temporary signs are often erected by pushing or driving one or more relatively thin posts or rods into the ground, which is easier and less disruptive, but also much less secure. It would be advantageous to place a support structure or anchor in the ground, and to attach above ground sign posts or the like to the anchor structure.

Various designs and approaches to providing such anchors are known in the prior art. In some designs the anchors are driven into the ground, and in other designs the anchors are placed in the conventional manner, by excavation and fill. Although anchor devices and structures known in the prior art provide effective support, they remain subject to significant limitations and disadvantages. Most of the designs known in the prior art are limited to use with a specific post configuration and dimension. A few designs are able to accommodate posts with limited variation in size, but not in configuration. Prior art anchors designed for use with square posts cannot be effectively used with round posts, and vice versa.

Support posts for, especially, professionally produced signs are provided in both square and round configurations, and in different sizes. It is desirable for an anchoring system to accommodate all common configurations and sizes. It is also desirable for an anchoring system to be easily adaptable to the use of other configurations and sizes without the need to replace the entire anchor structure. It is further desirable for an anchor structure to be unobtrusive when not in use to support a sign, without above ground obstructions that present a trip hazard and make maintenance chores such as mowing more difficult and potentially dangerous.

### SUMMARY OF THE INVENTION

The present invention provides a secure anchor structure that may be easily placed in the ground with minimal disruption of the location in which it is positioned, that can accommodate posts of several sizes and configurations with the same post receiver assembly, and that may be readily adapted to additional post sizes and configurations by interchanging post receiver assemblies on the same ground anchor assembly.

The anchor structure of the invention includes a ground anchor assembly and a post mounting assembly removably connected to the ground anchor assembly, allowing the ground anchor assembly to be installed without interference from or the potential for damage to the post mounting assembly. In the preferred embodiment the ground anchor assembly includes an elongate ground penetrating spike, with a mounting plate at its upper end and with stabilizing fins connected to and extending outwardly from the spike, which is to be driven into the ground until the mounting plate is flush with or slightly below the surface.

The post mounting assembly includes a base plate, to be connected to the mounting plate of the ground anchor assembly, and a post receiver for connection of a sign post. The post receiver is provided in a variety of configurations and dimensions to accommodate commonly used post configurations and dimensions. Alternatively, a dual post receiver, structured to receive and connect posts of several configurations and dimensions, may be utilized.

In an alternative embodiment the ground anchor assembly is formed with a screw shaft and a spiral screw plate instead of spike and fins, and is installed by screwing the ground anchor assembly into the ground until its mounting plate is at the desired elevation for connection of the post mounting assembly.

The structure and features of preferred and alternative embodiments of the anchor structure of the invention will be described in detail with reference to the accompanying drawing figures.

### BRIEF DESCRIPTION OF THE DRAWINGS

FIG. 1 is an elevation view showing two units of a preferred embodiment of the anchor structure of the invention in place and supporting a two post sign.

FIG. 2 is a side elevation view of the ground anchor assembly of a preferred embodiment of the anchor structure of the invention.

FIG. 3 is a top plan view of the ground anchor assembly shown in FIG. 2.

FIG. 4 is a top plan view of one embodiment of the post mounting assembly of the anchor structure of the invention.

FIG. 5 is a side elevation view of the post mounting assembly shown in FIG. 4.

FIG. 6 is a top plan view of another embodiment of the post mounting assembly of the anchor structure of the invention.

FIG. 7 is a side elevation view of the post mounting assembly shown in FIG. 6.

FIG. 8 is a top plan view of a different embodiment of the post mounting assembly of the anchor structure of the invention.

FIG. 9 is a top plan view of yet another embodiment of the post mounting assembly of the anchor structure of the invention.

FIG. 10 is a side elevation view of the post mounting assembly shown in FIG. 9.

FIGS. 11, 12, and 13 are cross-sectional illustrations of common configurations for prefabricated posts.

FIG. 14 is a side elevation view of an alternative embodiment of the ground anchor assembly.

FIG. 15 is a top plan view of the alternative embodiment of the ground anchor assembly shown in FIG. 14.

FIG. 16 is an elevation view showing a preferred embodiment of the ground anchor assembly partially driven into the ground within a shallow excavation.

FIG. 17 is an elevation view illustrating placement of the post mounting assembly and a post on a fully installed ground anchor assembly.

FIG. 18 is an elevation view showing the alternative embodiment of the ground anchor assembly partially screwed into the ground, and also showing a T-handle driver used for installation.

FIG. 19 is an elevation view of an installed anchor structure of the alternative embodiment, supporting a post and sign.

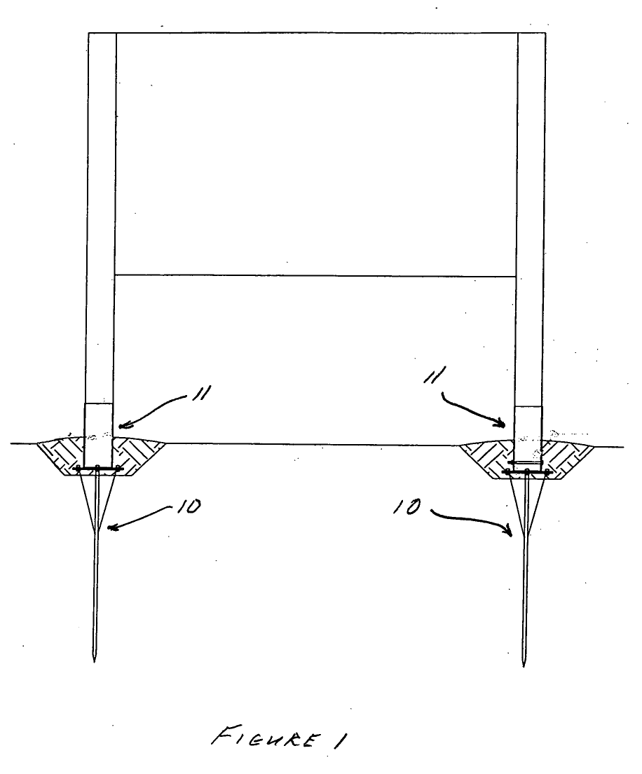

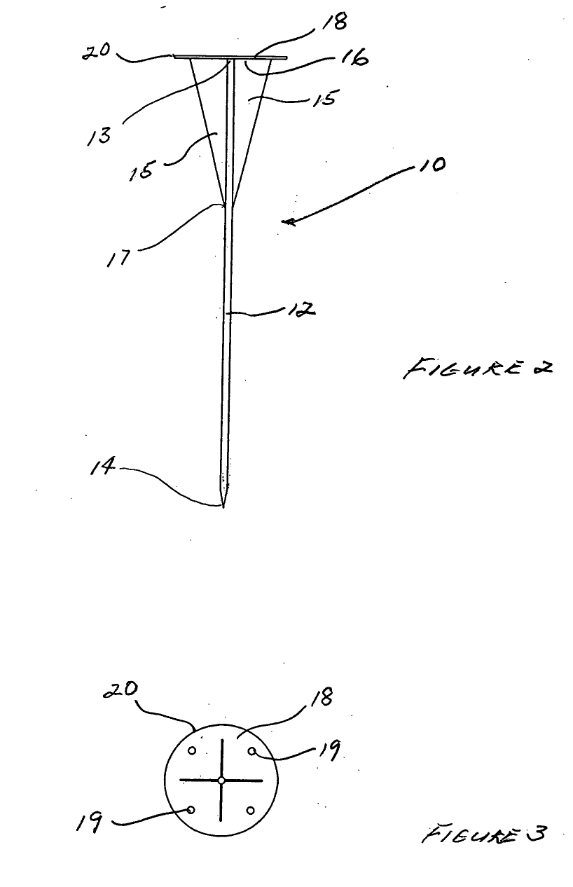

### DESCRIPTION OF THE INVENTION

The anchor structure of the invention includes a ground anchor assembly 10 and a post mounting assembly 11, which is removably connected to the ground anchor assembly. In the preferred embodiment, ground anchor assembly 10 includes an elongate ground penetrating spike 12, with a first, upper end 13 and a second, lower end 14. The preferred length of spike 12 is approximately twenty-four inches, but it is to be understood that the specific length of the spike is not critical to the scope of the invention, and other lengths may be readily used to accommodate different installation requirements and conditions.

A plurality of fins 15 are connected to spike 12 adjacent to its upper end 13 and extending along the length of the spike toward its lower end. Fins 15 are preferably right triangular plates disposed with the base 16 of each triangle adjacent to the upper end of spike 12 and extending outwardly perpendicular to the longitudinal axis of the spike. In the preferred embodiment the number of fins 15 is four, and the fins are symmetrically arrayed around spike 12. The number of fins is not critical to the scope of the invention, however, and other numbers and arrangements of fins 15 could be used. It is preferred that at least three fins be used, to maintain the stability of the ground anchor when embedded in the ground. In the preferred embodiment the length of fins 15 between the base and the apex 17 of the triangle be approximately one third the length of spike 12, but other proportional relationships could be used. Likewise, although the triangular fin configuration is preferred, other configurations could be used within the scope of the invention.

A mounting plate 18 is connected to the upper end 13 of spike 12, and preferably also connected to the base 16 of each fin 15. Mounting plate 18 is preferably a circular disk, with a diameter somewhat larger than twice the length of each fin base 16, centered on spike 12 and disposed perpendicular to the longitudinal axis of spike 12. The connection between the mounting plate and the spike and fins is preferably made by welding, but other means of connection could be used so long as a secure connection between the mounting plate and spike is formed. As a non-limiting example, mounting plate 18 could be provided with a central aperture and connected to spike 12 by a bolt extending though the central aperture and into a threaded aperture at the upper end of the spike. Mounting plate 18 is penetrated by a plurality of apertures 19 disposed around the plate inward from its outer edge 20. In the preferred embodiment the number of apertures 19 is four, but the specific number is not critical to the invention.

Post mounting assembly 11 includes a base plate 21 and a post receiver 22. Base plate 21 is preferably formed as a circular disk approximately equal in diameter to mounting plate 18, and includes a plurality of apertures 23 disposed around the plate inward from its outer edge 24. Apertures 23 are positioned to align with apertures 19 when base plate 21 is placed on mounting plate 18. Apertures 23 are preferably formed as slots, so that the alignment between apertures 23 and apertures 19 is maintained when base plate 21 rotated through a few degrees relative to mounting plate 18, to provide a degree of adjustability in the alignment of the post mounting assembly on the ground anchor assembly.

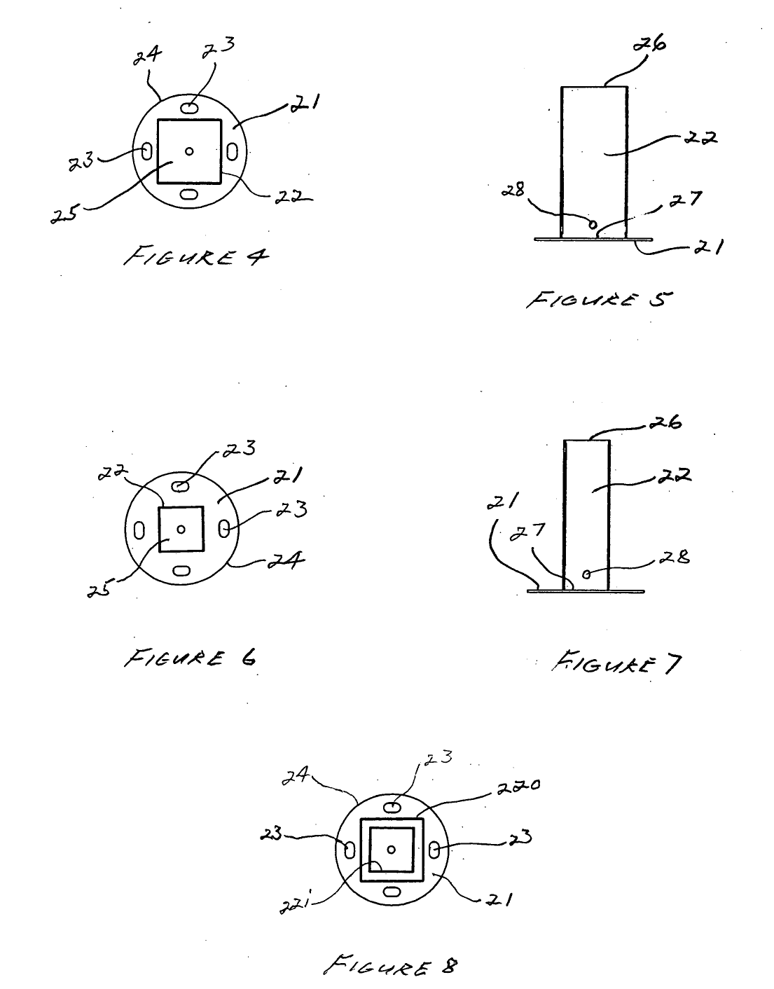

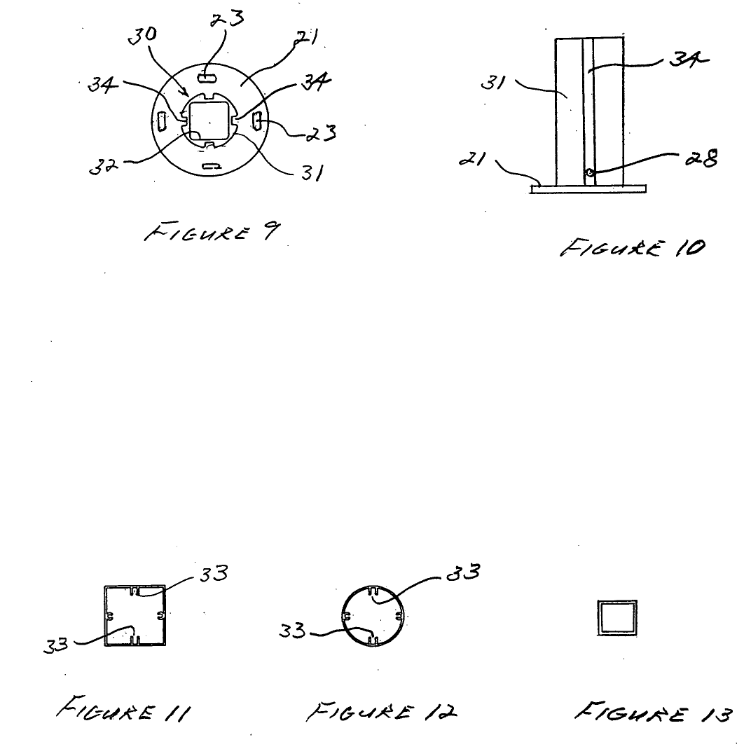

In the embodiment illustrated in FIGS. 4-7, post receiver 22 is a square sleeve with a hollow interior 25, an open first, or upper end 26, and a second, or lower end 27. Lower end 27 of the post receiver is preferably open, but could be closed if desired. Post receiver 22 is centered on base plate 21 with its longitudinal axis perpendicular to the base plate, and is firmly connected to the base plate, e.g, by welding, although other secure means of connection could be used. In this embodiment the inside cross-sectional dimensions of the post receiver are slightly larger than the outside cross-sectional dimensions of the posts to be supported. Commonly used prefabricated sign posts are provided in standard configurations and standard sizes. A typical square sign post is three and one fourth inches in outside dimension. A typical round sign post has a diameter of three and one fourth inches. To fit these standard posts, post receiver is square in configuration, with inside cross-sectional dimensions slightly larger than three and one fourth inches, so that these standard posts can be inserted into the hollow interior of the post receiver. Another commonly used prefabricated post type is a square post with cross-sectional dimensions of two inches, and a post receiver with inside cross-sectional dimensions of slightly more than two inches may be used for this post type. These dimensions are standard in the sign industry, but it is to be understood that the components of the anchor structure of the invention can be sized to accommodate posts of any size, and of any configuration. At least one set of aligned bolt apertures 28 are formed in opposed walls of the post receiver near its lower end 27, to receive an assembly bolt 29 through the interior of the post receiver. Matching apertures are formed in the lower end of the post to be supported by the anchor structure of the invention, to align with apertures 28 when the post is inserted into the post receiver. The close telescoping fit of the post in the post receiver provides secure retention and stability of the post, and the assembly bolt serves primarily to prevent removal of the post from the post receiver. If desired, however, a second set of apertures may be formed in the post receiver and post, offset from apertures 28, for a second assembly bolt to be placed either perpendicular or parallel to the first assembly bolt.

In a variation or alternative embodiment of the post mounting assembly described above, a post mounting assembly with an outer post receiver 22o and an inner post receiver 22i may be used, as illustrated in FIG. 8. The outer post receiver 22o is sized to receive three and one fourth inch posts, and the inner post receiver 22i is sized to receive two inch posts. In this embodiment apertures 28 extend through both post receivers. Standard prefabricated sign posts are hollow and open at their lower end, so the inner post receiver 22i will be received in the interior of a three and one fourth inch post without interference. When a two inch post is used a collar (not shown) may be installed to fill the gap between the post and the upper end of outer post receiver 22o. Again, it is to be understood that the stated dimensions are used as examples and are not limiting of the scope of the invention.

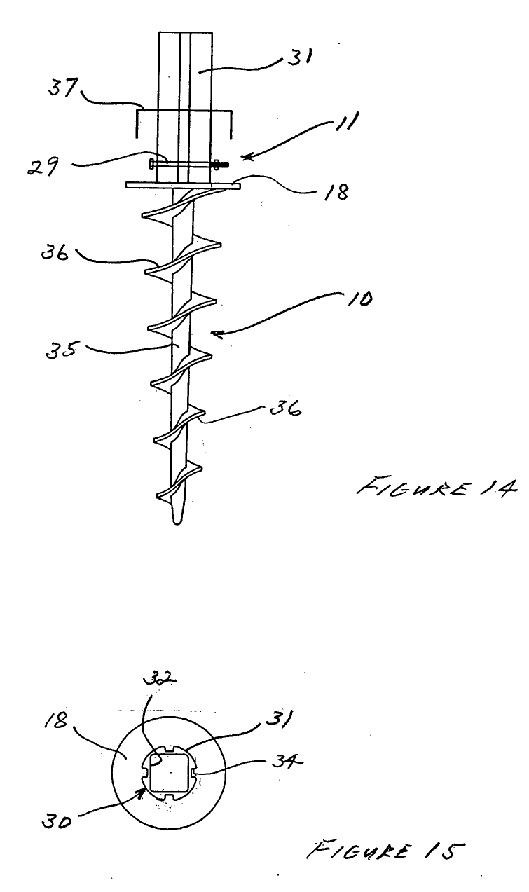

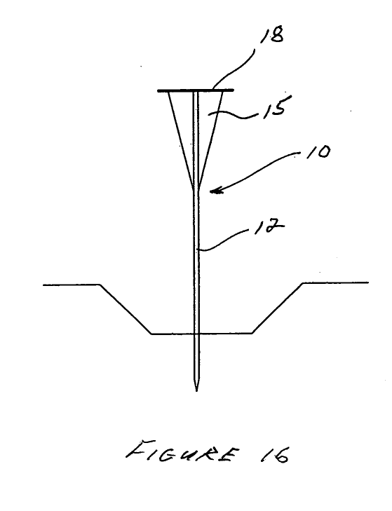

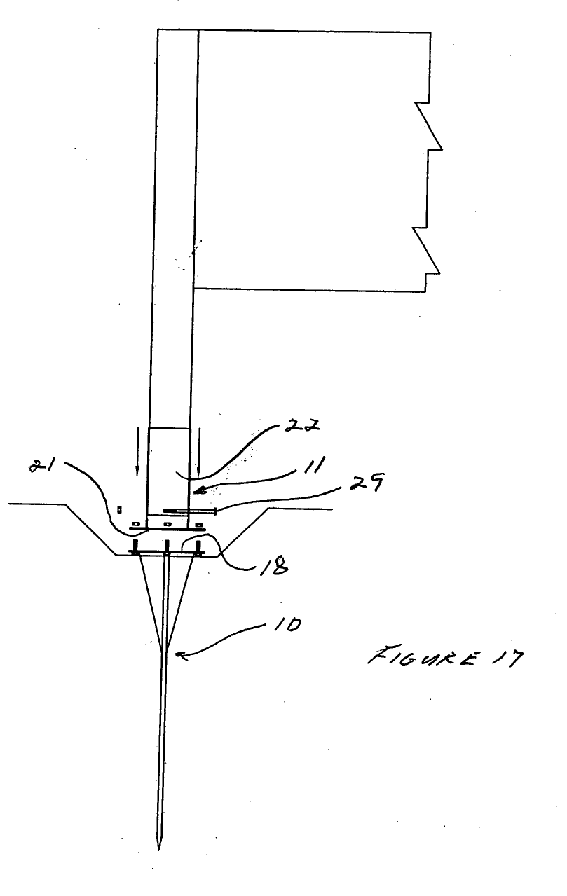

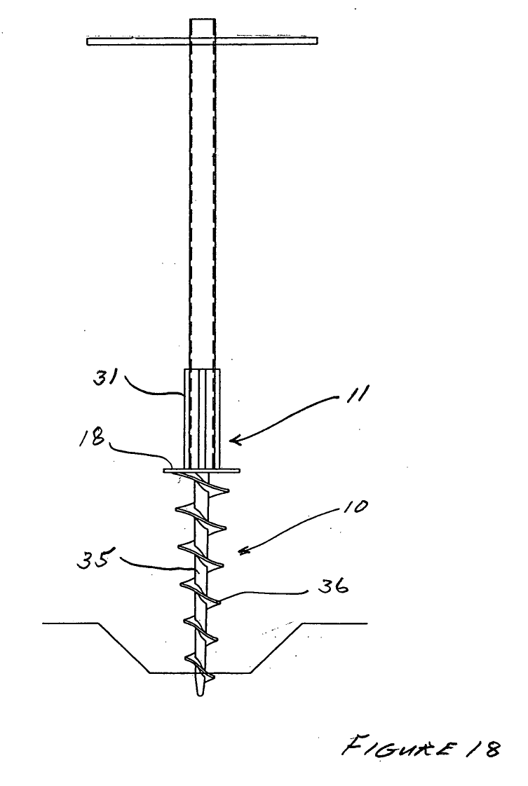

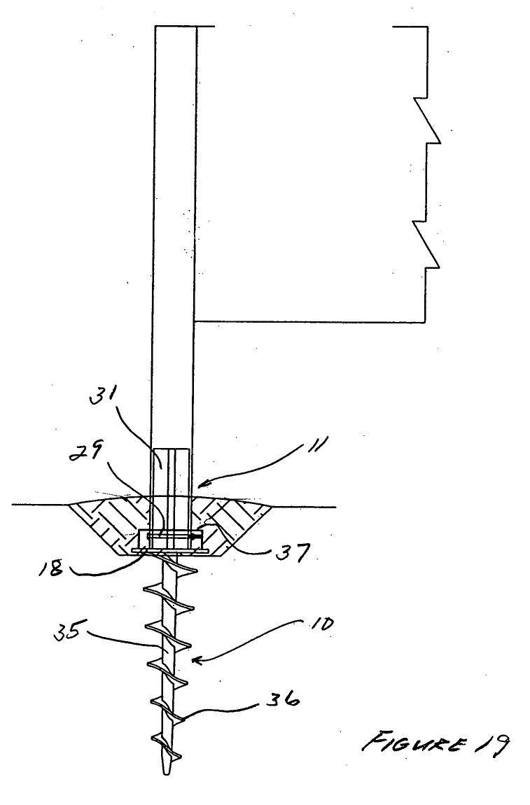

In another variation or alternative embodiment, shown in FIG. 9, post receiver 22 is replaced with a dual receiver 30. The receiver of this embodiment is desired to accommodate large (e.g., three and one fourth inch) square posts and round posts, and small (e.g., two inch) posts without interchanging the post mounting assembly. Receiver 30 includes an outer cylindrical tube 31 and an inner square tube 32 extending upward from base plate 21 in concentric orientation with tube 32 in the interior of tube 31. The outside diameter of tube 31 is slightly less than the interior cross-sectional dimension of, e.g., a three and one fourth inch hollow post. The inside dimension of tube 32 is slightly greater than the outside dimension of, e.g, a two inch post. Apertures 28 are formed in receiver 30 to receive an assembly bolt 29 as described above. The circular cross-sectional configuration of tube 31 allows it to be received in the interior of both a round post and a square post and assure secure retention of both post configurations. Many prefabricated sign posts are formed with tabs 33 extending into the hollow interior of the post from the post walls, and grooves 34 may be formed in tube 31 to receive tabs 33 when the post is placed over the receiver. A small, e.g., two inch, post may be inserted into the interior of tube 32. A collar (not shown) may be used, if desired, to smooth the transition between the post and the upper end of the post receiver when a small post is used. Although it is preferred that receiver 30 be connected to a base plate 21 which is removably connected to mounting plate 18, receiver 30 could be permanently connected directly to mounting plate 18.

To install a sign, or to mount a post for any desired purpose, utilizing the embodiments of the post anchor structure described above, a shallow excavation is preferably made in the location where each post is to be placed. The purpose of the shallow excavation is to position the upper end of the ground anchor assembly and the lower end of the post mounting assembly slightly below finished ground level, and although preferred is not functionally required. The lower end of spike 12 of the ground anchor assembly 10 is positioned at the center of the post location, and the ground anchor assembly is driven into the ground until mounting plate 18 is near the bottom of the shallow excavation, or near the surface of the ground if the excavation step is omitted. A protective impact plate or other cushioning structure (not shown) may be temporarily connected to the upper end of spike 12 and mounting plate 18 to prevent damage to the ground anchor assembly while it is driven into the ground, and then removed when the ground anchor assembly is set. Once the ground anchor assembly is set and any protective structure used during the driving procedure is removed, post mounting assembly 11 is connected to the ground anchor assembly by placing base plate 21 on mounting plate 18, aligning apertures 23 with apertures 19, and securing the assemblies together with bolts or other suitable means. A post is then inserted in or placed over (depending on the embodiment used) the post receiver, and assembly bolt(s) 29 are inserted and tightened, securely and firmly positioning and anchoring the post. As an alternate assembly method the post receiver may be attached to the post first, either in the field or prior to delivery of the post, and the pre-assembled post and post receiver assembly secured to the ground anchor assembly as described above. The shallow excavation is then filled with the removed soil or, if desired, with another material such as gravel or even concrete if a more permanent installation is intended, to fully cover the ground anchor assembly and the lower portion of the post mounting assembly. If a multiple post sign or other structure is being erected, an anchor structure is placed for each post, taking care to properly position and align the anchor structures, and the posts are simultaneously engaged with the anchor structures.

When or if a sign or post is to be removed or changed, it is necessary to excavate only the fill material covering the joint between the ground anchor assembly and the post mounting assembly so that assembly bolt(s) 29 can be removed. With the assembly bolt(s) removed the post(s) can be easily lifted from the post mounting assembly. If another sign is to be installed in place of the one removed, the post(s) are engaged with the respective post mounting assemblies as described above, and the fill material replaced, quickly and easily completing the operation. If the existing sign or post is to be removed without immediate replacement, the post mounting assembly 11 can be easily disconnected from the ground anchor assembly and removed, leaving the ground anchor assembly in place for later use. In this situation the upper end of the ground anchor assembly remains below grade or at grade, and presents no physical hazard or visual obstruction.

In an alternative embodiment of the anchor structure of the invention, a ground anchor assembly that is screwed rather than driven into the ground is provided. As illustrated in FIG. 14, in this embodiment spike 12 and fins 15 are replaced by screw shaft 35 and spiraling screw plate 36. Mounting plate 18 is connected to upper end 37 of shaft 35 and to the upper end of screw plate 36. In the illustrated embodiment a post receiver 30 is connected directly to mounting plate 18. It is to be understood, however, that mounting plate 18 may also be provided with apertures 19 and a removable post mounting assembly 11 of one of the embodiments described above connected to mounting plate 18. The direct connection of the post receiver to mounting plate 18 is appropriate for a situation in which a sign post for any other purpose is intended to be permanently in place, and the use of a removable post mounting assembly is appropriate for a situation in which the sign or post may be removed without immediate replacement.

A protective cover 37, shown in FIGS. 14 and 19, may be used with any embodiment of the anchor structure of the invention to cover and protect the attachment bolt or bolts, which are below grade after the shallow excavation is filled, from corrosion and facilitate removal of a post from the anchor structure.

The screw type alternative embodiment of the anchor structure is installed with the post receiver or post mounting assembly in place. A T-handle or other rotating means is engaged in the post receiver, as illustrated in FIG. 18, and used to rotate the structure to screw the anchor into the ground to the desired depth. The steps for installing the anchor structure(s) and the post(s) to be supported are essentially the same as described above.

The foregoing description of preferred and alternative embodiments of the anchor structure of the invention is intended to be illustrative and not limiting. Further alternative embodiments and variations may be devised within the scope of the following claims.

1. An in-ground anchor structure for supporting a post, comprising,
a ground anchor assembly having an elongate spike with a first end and a second end and a longitudinal axis, and a generally planar mounting plate connected to said first end of said spike with the plane of said mounting plate perpendicular to said longitudinal axis of said spike; and
a post mounting assembly having a generally planar base plate to be received upon and removably connected to said mounting plate of said ground anchor assembly in parallel relation thereto, and a post receiver formed as a hollow sleeve with an open first end and a second end and a longitudinal axis, disposed on and connected at said second end to said base plate with said longitudinal axis of said sleeve perpendicular to the plane of said base plate, said sleeve configured and dimensioned to receive an end portion of the post to be supported in said hollow interior thereof through said open first end.

2. The in-ground anchor assembly of claim 1, wherein said ground anchor assembly further includes a plurality of fins disposed perpendicular to said spike and connected to said spike and to said mounting plate.
